(19) United States
(12) Patent Application Publication
(10) Pub. No.: US 2015/0246635 A1
(43) Pub. Date: Sep. 3, 2015

(54) INVISIBLE LIGHTING FOR VEHICLES

(71) Applicant: GM GLOBAL TECHNOLOGY OPERATIONS LLC, Detroit, MI (US)

(72) Inventors: Jay H. Ovenshire, Rochester, MI (US); Hesham A. Ezzat, Troy, MI (US)

(73) Assignee: GM GLOBAL TECHNOLOGY OPERATIONS LLC, Detroit, MI (US)

(21) Appl. No.: 14/193,586

(22) Filed: Feb. 28, 2014

(51) Int. Cl. B60Q 1/26; B60Q 1/44

(52) U.S. Cl. CPC B60Q 1/2653; B60Q 1/44

(57) ABSTRACT

A vehicle includes a body panel, a light, and a concealment panel. The body panel extends along a longitudinal axis between a forward end and a rearward end. The body panel defines an opening. The light is operable to illuminate in response to an input. The concealment panel is movably attached to the body panel. The concealment panel is movable relative to the body panel from a closed position to an open position, in response to the input. The concealment panel covers the opening such that the light is concealed when the concealment panel is in the closed position. Likewise, the concealment panel at least partially uncovers the opening such that the light is revealed when the concealment panel is in the open position.

### TECHNICAL FIELD

The present disclosure is related to selectively concealable lighting for vehicles.

### BACKGROUND

Vehicles include exterior lights, including tail lamps, turn signals, rear fog lamps, a center high mount stop light (CHiMSL), and the like. These exterior lights are configured to be illuminated to make the vehicle visible.

### SUMMARY

One possible aspect of the disclosure provides a brake lighting assembly for a vehicle. The brake lighting assembly includes a light and a concealment panel. The light is operable to illuminate in response to an input. The concealment panel is movable between a closed position and an open position, in response to the input. The light is concealed when the concealment panel is in the closed position. Likewise, the light is revealed when the concealment panel is in the open position.

In another aspect of the disclosure, a vehicle includes a body panel and a brake lighting assembly. The body panel extends along a longitudinal axis between a forward end and a rearward end. The body panel defines an opening. The brake lighting assembly includes a light and a concealment panel. The light is operable to illuminate in response to an input. The concealment panel is movably attached to the body panel. The concealment panel is movable, relative to the body panel, between a closed position and an open position, in response to the input. The concealment panel covers the opening such that the light is concealed when the concealment panel is in the closed position. Likewise, the concealment panel at least partially uncovers the opening such that the light is revealed when the concealment panel is in the open position.

In yet another aspect of the disclosure, a vehicle includes a body panel an a brake lighting assembly. The body panel extends along a longitudinal axis, between a forward end and a rearward end. The brake lighting assembly includes a light and a concealment panel. The light is operable to illuminate in response to an input. The concealment panel is movably attached to the body panel. The concealment panel is movable relative to the body panel from a closed position to an open position, in response to the input. The concealment panel is movable relative to the body panel from the open position to the closed position, in an absence of the input. The light is concealed within an exterior of the vehicle and the light is not illuminated when the concealment panel is in the closed position. The light is revealed to the exterior of the vehicle and the light is illuminated when the concealment panel is in the open position.

The above features and advantages and other features and advantages of the present teachings are readily apparent from the following detailed description of the best modes for carrying out the present teachings when taken in connection with the accompanying drawings.

### BRIEF DESCRIPTION OF THE DRAWINGS

FIG. 1 is a schematic rear end view of a vehicle.

FIG. 2 is a schematic rear end view of the vehicle of FIG. 1 with rear brake lighting visible.

FIG. 3 is a schematic diagrammatic view of a rear brake lighting assembly of the vehicle of FIG. 1 with a concealment panel in a closed position and a light not illuminated.

FIG. 4 is a schematic diagrammatic view of the rear brake lighting assembly of the vehicle of FIG. 2 with the concealment panel in an open position and the light illuminated.

FIG. 5 is a schematic diagrammatic view of another embodiment of the rear brake lighting assembly of the vehicle of FIG. 1 with a concealment panel in a closed position and a light not illuminated.

FIG. 6 is a schematic diagrammatic view of another embodiment of the rear brake lighting assembly of the vehicle of FIG. 2 with the concealment panel rotated into the open position and the light illuminated.

FIG. 7 is a schematic diagrammatic view of yet another embodiment of the rear brake lighting assembly of the vehicle of FIG. 1 with a concealment panel in a closed position and a light not illuminated.

FIG. 8 is a schematic diagrammatic view of yet another embodiment of the rear brake lighting assembly of the vehicle of FIG. 2 with the concealment panel slid into the open position and the light illuminated.

### DETAILED DESCRIPTION

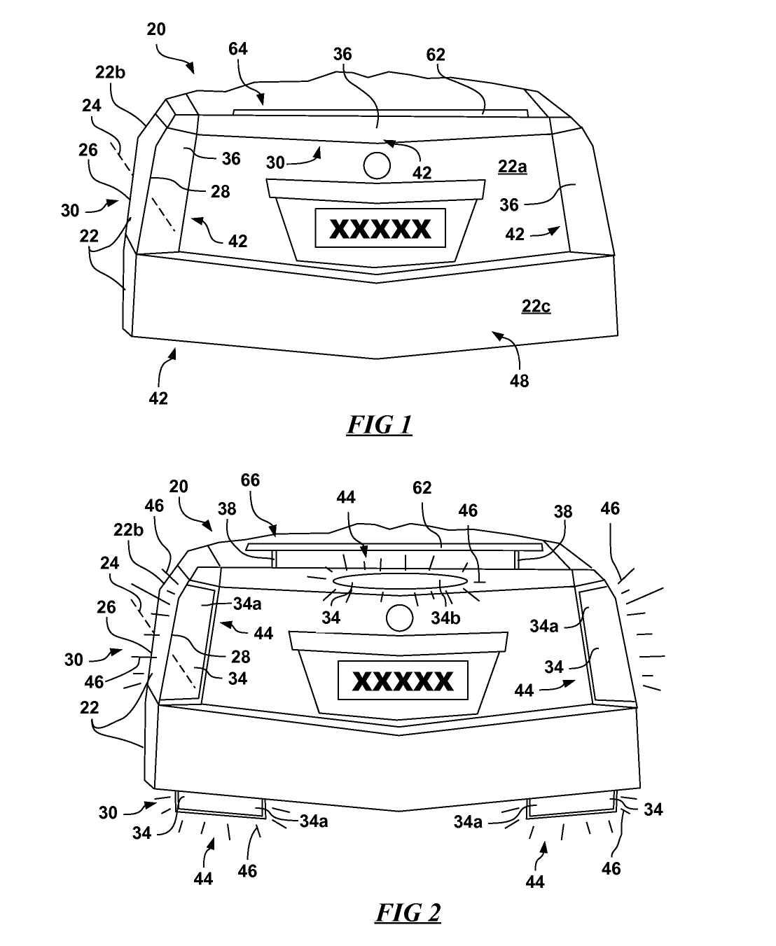

Referring to the drawings, wherein like reference numbers refer to like components throughout the several Figures, a vehicle 20 is shown schematically in FIGS. 1 and 2. The vehicle 20 includes a body panel 22 extending along a longitudinal axis 24 between a forward end 26 and a rearward end 28.

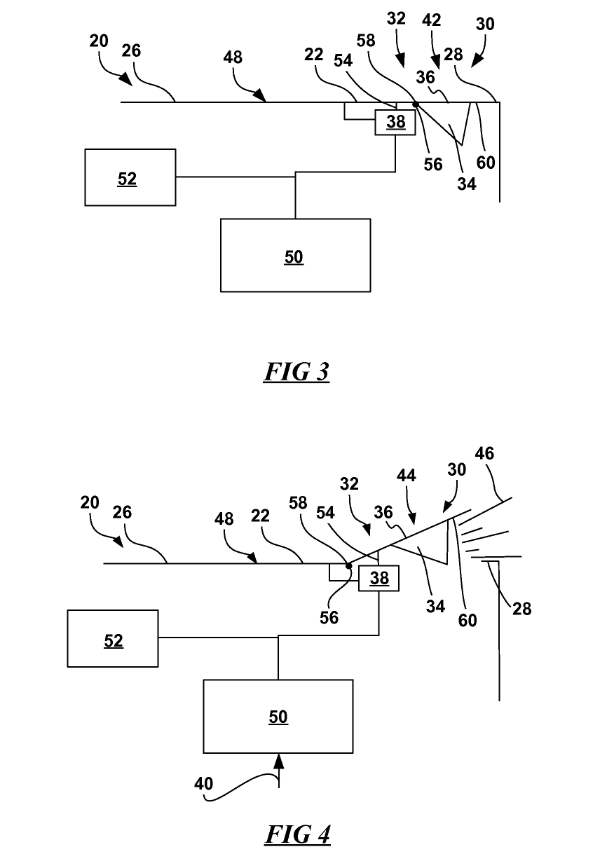

Referring to FIGS. 3-8, the vehicle 20 also includes at least one brake lighting assembly 30 operatively attached to the rearward end 28 of the body panel 22. The body panel 22 may be a deck lid 22a, a rear quarter panel 22b, a rear fascia 22c, and the like. Referring to FIGS. 4-8, the body panel 22 defines an opening 32 corresponding to each brake lighting assembly 30.

Each brake lighting assembly 30 includes a light 34, a concealment panel 36, and an actuator mechanism 38. The light 34 may be a tail lamp 34a, a center high mount stop light (CHiMSL) 34b, rear fog lamps, turn signals, or any other light configured for illuminating a rear end 35 of the vehicle 20. The light 34 is operable to illuminate in response to an input 40. The input 40 may be the result of the vehicle 20 operator applying the brakes of the vehicle 20 or otherwise activating exterior 48 lighting of the vehicle 20. The input 40 may be an electrical signal.

The concealment panel 36 for each brake lighting assembly 30 is movably attached to the body panel 22. More specifically, the concealment panel 36 is movable, relative to the body panel 22, between a closed position 42, as illustrated in FIGS. 3, 5, and 7, and an open position 44, as illustrated in FIGS. 4, 6, and 8, in response to the input 40. The concealment panel 36 covers the opening 32, such that light 34 is concealed, when the concealment panel 36 is in the closed position 42. Likewise, the concealment panel 36 at least partially uncovers the opening 32, such that the light 34 is revealed, when the concealment panel 36 is in the open position 44. Therefore, in response to the input 40, the light 34 is illuminated, as indicated by 46, and the concealment panel 36 moves to the open position 44, thus revealing the light 34 to an exterior 48 of the vehicle 20. Likewise, in an absence of the input 40, the light 34 is not illuminated and the concealment panel 36 moves to the closed position 42, such that the light 34 is not visible to the exterior 48 of the vehicle 20. In the closed position 42, the light 34 is concealed or is otherwise “invisible” to the exterior 48 of the vehicle 20. When in the closed position 42, the concealment panel 36 may be configured relative to the body panel 22 such that the concealment panel 36 is camouflaged and not otherwise discernible.

The actuator mechanism 38 is operatively connected to each concealment panel 36. The actuator mechanism 38 may operatively interconnect the concealment panel 36 and the body panel 22. Alternatively, the actuator mechanism 38 may operatively connect the concealment panel 36 and any other portion of the vehicle 20. The actuator mechanism 38 is configured to move the respective concealment panel 36 from the closed position 42 to the open position 44, in response to the input 40. Likewise, the actuator mechanism 38 is configured to move the concealment panel 36 from the open position 44 to the closed position 42, in an absence of the input 40.

Each actuator mechanism 38 is operatively connected to a controller 50 and an energy storage device 52, such as a battery. The controller 50 may be configured to receive the input and send a signal to the energy storage device 52 to provide electrical current to the actuator mechanism 38.

The actuator mechanism 38 may include a Shape Memory Alloy (SMA) member 54 coupled to the concealment panel 36. The SMA member 54 is configured for moving the concealment panel 36 from the closed position 42 to the open position 44, in response to the input 40. The input 40 may be an electrical signal.

In response to an electrical current, the SMA member 54 heats up and contracts. Contraction of the SMA member 54 causes the concealment panel 36 to move from the closed position 42, shown in FIGS. 1 and 3, into the open position 44, shown in FIGS. 2 and 4. In the absence of the electrical current, the SMA member 54 cools and returns to an original shape, i.e., length, of the SMA member 54.

The SMA member 54 includes and is manufactured from a shape memory alloy. Suitable shape memory alloys can exhibit a one-way shape memory effect, an intrinsic two-way effect, or an extrinsic two-way shape memory effect depending on the alloy composition and processing history. The two phases that occur in shape memory alloys are often referred to as martensite and austenite phases. The martensite phase is a relatively soft and easily deformable phase of the shape memory alloys, which generally exists at lower temperatures. The austenite phase, the stronger phase of shape memory alloys, occurs at higher temperatures. Shape memory materials formed from shape memory alloy compositions that exhibit one-way shape memory effects do not automatically reform, and depending on the shape memory material design, will likely require an external mechanical force to reform the shape orientation that was previously exhibited. Shape memory materials that exhibit an intrinsic shape memory effect are fabricated from a shape memory alloy composition that will automatically reform themselves.

The temperature at which the shape memory alloy remembers its high temperature form when heated can be adjusted by slight changes in the composition of the alloy and through heat treatment. In nickel-titanium shape memory alloys, for example, it can be changed from above about 100° C. to below about −100° C. The shape recovery process occurs over a range of just a few degrees and the start or finish of the transformation can be controlled to within a degree or two depending on the desired application and alloy composition. The mechanical properties of the shape memory alloy vary greatly over the temperature range spanning their transformation, typically providing the shape memory material with shape memory effects as well as high damping capacity. The inherent high damping capacity of the shape memory alloys can be used to further increase the energy absorbing properties.

Suitable shape memory alloy materials include without limitation nickel-titanium based alloys, indium-titanium based alloys, nickel-aluminum based alloys, nickel-gallium based alloys, copper based alloys (e.g., copper-zinc alloys, copper-aluminum alloys, copper-gold, and copper-tin alloys), gold-cadmium based alloys, silver-cadmium based alloys, indium-cadmium based alloys, manganese-copper based alloys, iron-platinum based alloys, iron-platinum based alloys, iron-palladium based alloys, and the like. The alloys can be binary, ternary, or any higher order so long as the alloy composition exhibits a shape memory effect, e.g., change in shape orientation, damping capacity, and the like.

Referring to the brake lighting assembly 30 shown in FIGS. 3 and 4, the concealment panel 36 is disposed within the opening 32 and may include an end 56 that is operatively attached to the concealment panel 36 at a pivot location 58. As such, the concealment panel 36 pivots relative to the body panel 22 at the pivot location 58, between the closed position 42 (shown in FIG. 3) and the open position 44 (shown in FIG. 4). As such, the concealment panel 36 at least partially uncovers the opening 32 when in the open position 44. The light 34 may be operably attached to the first side 60 of the concealment panel 36 such that the light 34 moves with the concealment panel 36 to be revealed to the exterior 48 to the vehicle 20 when the concealment panel 36 pivots about the pivot location 58, into the open position 44. Alternatively, the light 34 is operatively attached to the body panel 22 and is disposed in the opening 32 such that the light 34 is revealed to the exterior 48 of the vehicle 20 when the concealment panel 36 pivots to the open position 44 to at least partially uncover the opening 32.

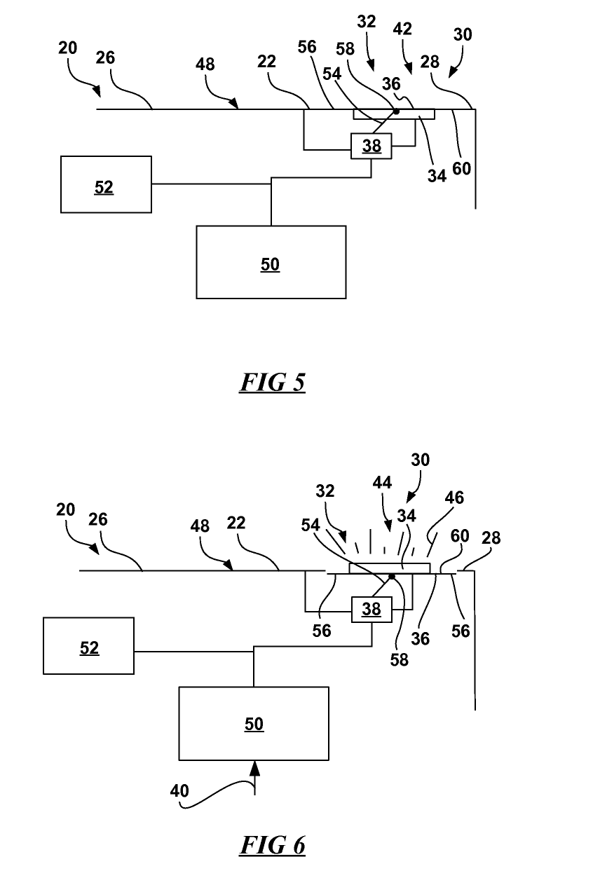

Referring to the brake lighting assembly 30 shown in FIGS. 5 and 6, the concealment panel 36 is disposed within the opening 32 and is pivotable relative to the body panel 22 at a pivot location 58 disposed between opposing ends 56 of the concealment panel 36. As such, the concealment panel 36 pivots relative to the body panel 22 at the pivot location 58, between the closed position 42 (shown in FIG. 5) and the open position 44 (shown in FIG. 6). The concealment panel 36 may be configured to pivot at a location 58 that is centered between the opposing ends 56 of the concealment panel 36. Alternatively, the concealment panel 36 may be configured to pivot at a location 58 that is offset from a center between the opposing ends 56 of the concealment panel 36. The concealment panel may be configured to pivot 180 degrees between the closed position 42 and the open position 44. As such, the concealment panel 36 at least partially uncovers the opening 32 when pivoting from the closed position 42 to the open position 44. When in the open position 44, the concealment panel 36 may be disposed within the opening 32 or be disposed to at least partially uncover the opening 32. The light 34 may be operably attached to the first side 60 of the concealment panel 36 such that the light 34 moves with the concealment panel 36 to be revealed to the exterior 48 of the vehicle 20 when the concealment panel 36 pivots about the pivot location 58, into the open position 44.

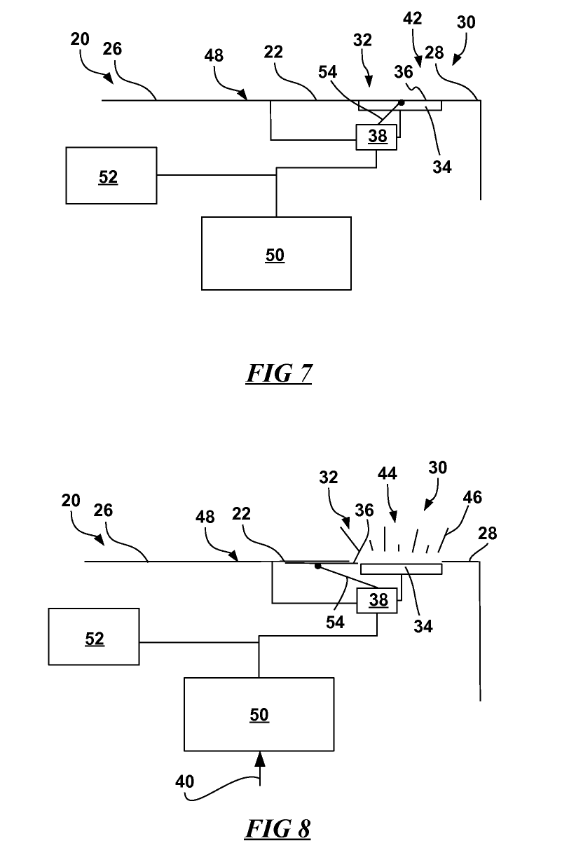

Referring now to the brake lighting assembly 30 shown in FIGS. 7 and 8, the concealment panel 36 is disposed within the opening 32 when in the closed position 42. The concealment panel 36 is slidable, relative to the body panel 22, such that the concealment panel 36 moves out of the opening 32, to at least partially uncover the opening 32, when the concealment panel 36 is in the open position 44. The light 34 is disposed within the opening 32 such that the light 34 is revealed to the exterior 48 of the vehicle 20 when the concealment panel 36 slides relative to the body panel 22 to at least partially uncover the opening 32.

Referring again to FIGS. 1 and 2, the vehicle 20 may also include a spoiler 62. The spoiler 62 may be operatively attached to the body panel 22, such as the deck lid, proximate the rearward end 28. One or more actuator mechanisms 38 may operatively interconnect the spoiler 62 and the body panel 22. The actuator mechanisms 38 are configured to move the spoiler 62 from a retracted position 64, as shown in FIG. 1, to an extended position 66, as shown in FIG. 2, in response to the input 40. Additionally, the lights 34 of the vehicle 20 may be configured to continuously flash in response to the input 40.

While the best modes for carrying out the many aspects of the present teachings have been described in detail, those familiar with the art to which these teachings relate will recognize various alternative aspects for practicing the present teachings that are within the scope of the appended claims.

1. A brake lighting assembly for a vehicle, the brake lighting assembly comprising:
a light operable to illuminate in response to an input; and
a concealment panel movable between a closed position and an open position, in response to the input;
wherein the light is concealed when the concealment panel is in the closed position; and
wherein the light is revealed when the concealment panel is in the open position.

2. A brake lighting assembly, as set forth in claim 1, further comprising an actuator mechanism operatively connected to the concealment panel;
wherein the actuator mechanism is configured to move the concealment panel from the closed position to the open position, in response to the input.

3. A brake lighting assembly, as set forth in claim 2, wherein the actuator mechanism is configured for moving the concealment panel from the open position and the closed position, in an absence of the input.

4. A brake lighting assembly, as set forth in claim 3, wherein the actuator mechanism includes a shape memory alloy (SMA) member.

5. A brake lighting assembly, as set forth in claim 4, wherein the input is an electrical signal.

6. A brake lighting assembly, as set forth in claim 5, wherein the SMA member is configured to contract in response to heat generated by the electrical signal.

7. A brake lighting assembly, as set forth in claim 1, wherein the concealment panel is operatively connected to the light such that the light moves with the concealment panel between the closed position and the open position.

8. A brake lighting assembly, as set forth in claim 1, wherein the concealment panel is configured to move relative to the light, between the closed position and the open position.

9. A vehicle comprising:
a body panel extending along a longitudinal axis between a forward end and a rearward end;
wherein the body panel defines an opening; and
a brake lighting assembly including:
a light operable to illuminate in response to an input; and
a concealment panel movably attached to the body panel;
wherein the concealment panel is movable relative to the body panel from a closed position to an open position, in response to the input;
wherein the concealment panel covers the opening such that the light is concealed when the concealment panel is in the closed position; and
wherein the concealment panel at least partially uncovers the opening such that the light is revealed when the concealment panel is in the open position.

10. A vehicle, as set forth in claim 9, further comprising an actuator mechanism operatively connected to the concealment panel;
wherein the actuator mechanism is configured to move the concealment panel from the closed position to the open position, in response to the input.

11. A vehicle, as set forth in claim 10, wherein the actuator mechanism is configured for moving the concealment panel from the open position and the closed position, in an absence of the input.

12. A vehicle, as set forth in claim 11, wherein the actuator mechanism includes a shape memory alloy (SMA) member.

13. A vehicle, as set forth in claim 12, wherein in input is an electrical signal.

14. A vehicle, as set forth in claim 13, wherein the SMA member is configured to contract in response to heat generated by the electrical signal.

15. A vehicle, as set forth in claim 9, wherein the concealment panel is operatively connected to the light such that the light moves with the concealment panel, between the closed position and the open position.

16. A vehicle, as set forth in claim 9, wherein the concealment panel is configured to move relative to the light, between the closed position and the open position.

17. A vehicle, as set forth in claim 9, further comprising:
a spoiler operatively attached to the body panel;
wherein the spoiler is configured to move from a retracted position to an extended position, in response to the input.

18. A vehicle comprising:
a body panel extending along a longitudinal axis between a forward end and a rearward end; and
a brake lighting assembly including:
a light operable to illuminate in response to an input;
a concealment panel movably attached to the body panel;
wherein the concealment panel is movable relative to the body panel from a closed position to an open position, in response to the input;
wherein the concealment panel is movable relative to the body panel from the open position to the closed position, in an absence of the input;
wherein the light is concealed within an exterior of the vehicle and the light is not illuminated when the concealment panel is in the closed position; and
wherein the light is revealed to the exterior of the vehicle and the light is illuminated when the concealment panel is in the open position.

19. A vehicle, as set forth in claim 18, further comprising an actuator mechanism connected to the concealment panel;
wherein the actuator mechanism moves the concealment panel from the closed position to the open position, in response to the input;
wherein the actuator mechanism includes a shape memory alloy (SMA) member; and
wherein in input is an electrical signal.

20. A vehicle, as set forth in claim 19, further comprising a spoiler operatively attached to the body panel;
wherein the spoiler moves from a retracted position to an extended position, in response to the input.
